(19) United States
(12) Patent Application Publication
(10) Pub. No.: US 2022/0138405 A1
(43) Pub. Date: May 5, 2022

(54) DICTIONARY EDITING APPARATUS AND DICTIONARY EDITING METHOD

(71) Applicant: KABUSHIKI KAISHA TOSHIBA, Tokyo (JP)

(72) Inventors: Kenji IWATA, Machida Tokyo (JP); Takehiko KAGOSHIMA, Yokohama Kanagawa (JP)

(73) Assignee: KABUSHIKI KAISHA TOSHIBA, Tokyo (JP)

(21) Appl. No.: 17/412,437

(22) Filed: Aug. 26, 2021

(30) Foreign Application Priority Data
Nov. 5, 2020 (JP) 2020-184918

(51) Int. Cl. G06F 40/166; G06F 40/242; G06K 9/20

(52) U.S. Cl. CPC G06F 40/166; G06K 9/2054; G06F 40/242

(57) ABSTRACT

According to one embodiment, a dictionary editing apparatus includes processing circuitry. The processing circuitry is configured to extract words from text data, append character pronunciations to the extracted words, and specify, when a modification is made to word information including the extracted words and the appended character pronunciations, a modification candidate that is a word or character pronunciation to be modified in relation to the modification.

### CROSS-REFERENCE TO RELATED APPLICATIONS

This application is based upon and claims the benefit of priority from Japanese Patent Application No. 2020-184918, filed Nov. 5, 2020, the entire contents of which are incorporated herein by reference.

### FIELD

Embodiments described herein relate generally to a dictionary editing apparatus and a dictionary editing method.

### BACKGROUND

For improvements to be made in the precision of speech recognition, it is important to register, in advance, in a dictionary referred to by a speech recognition engine, both technical terms often uttered in settings where speech recognition is actually utilized and words that are unknown to the engine. However, it is difficult to manually list up such technical terms and unknown words and add character pronunciations to them.

On the other hand, if a function of reading text data related to a setting where speech recognition is utilized (e.g. in the case of recognizing speech in a university class, lecture material), automatically extracting technical terms and unknown words from the text data, and automatically appending character pronunciations to the extracted technical terms and unknown words is provided, it would be easy to register the technical terms and the unknown words in a dictionary. However, there is a possibility that the automatically extracted technical terms and unknown words and the automatically appended character pronunciations would be incorrect. Accordingly, it is necessary to manually perform a final check of the automatically extracted technical terms and unknown words and the automatically appended character pronunciations. A large number of automatically extracted words renders it difficult to check all of the automatically extracted words and the automatically appended character pronunciations.

The above-described manual check to confirm whether the automatically extracted technical terms and unknown words are correct and whether the character pronunciations automatically appended thereto are correct thus incurs considerable cost.

### BRIEF DESCRIPTION OF THE DRAWINGS

FIG. 1 is a block diagram showing a dictionary editing apparatus according to an embodiment.

FIG. 2 is a flowchart showing an operation example of the dictionary editing apparatus in FIG. 1.

FIG. 3 is a diagram showing an example of a screen on which a display unit shown in FIG. 1 displays a word list.

FIG. 4 is a diagram illustrating a highlighting method according to the embodiment.

FIG. 5 is a diagram illustrating a highlighting method according to the embodiment.

FIG. 6 is a diagram illustrating a highlighting method according to the embodiment.

FIG. 7 is a diagram illustrating a highlighting method according to the embodiment.

FIG. 8 is a block diagram showing a hardware configuration of an information processing apparatus according to the embodiment.

### DETAILED DESCRIPTION

According to one embodiment, a dictionary editing apparatus includes processing circuitry. The processing circuitry is configured to extract words from text data, append character pronunciations to the extracted words, and specify, when a modification is made to word information including the extracted words and the appended character pronunciations, a modification candidate that is a word or character pronunciation to be modified in relation to the modification.

According to the embodiment, there is provided a technique of enabling cost reduction in the checking of word extraction results and character pronunciation appendage results.

Hereinafter, embodiments will be described with reference to the accompanying drawings. According to an embodiment, there is provided a technique of assisting a user operation when words are added to a dictionary used for applications such as speech recognition. In the description that follows, let us assume the presence of a dictionary used in speech recognition (hereinafter referred to as a “speech recognition dictionary”). A speech recognition dictionary may take the form of information in which a word, a character pronunciation of the word, and phonemes corresponding to the character pronunciation are associated.

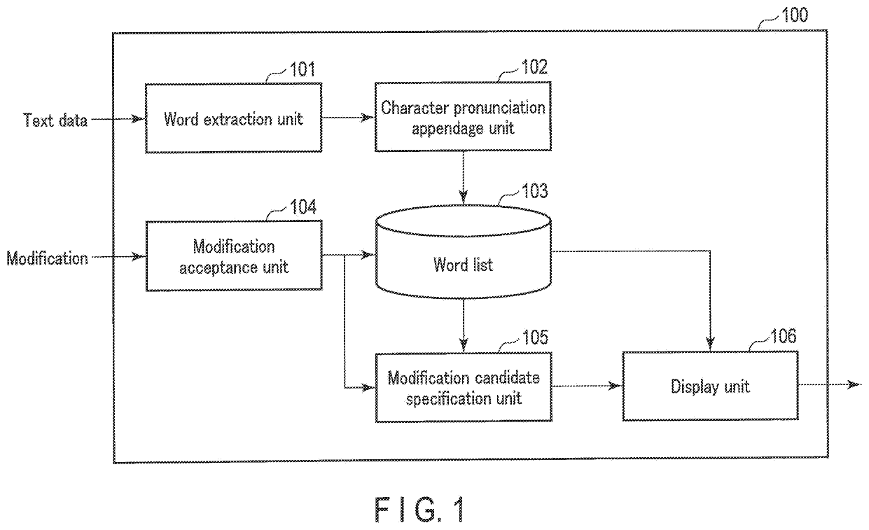

FIG. 1 schematically shows a dictionary editing apparatus 100 according to an embodiment. As shown in FIG. 1, the dictionary editing apparatus 100 includes a word extraction unit 101, a character pronunciation appendage unit 102, a word list 103, a modification acceptance unit 104, a modification candidate specification unit 105, and a display unit 106.

The word extraction unit 101 receives text data, extracts candidate words to be added to the speech recognition dictionary from the text data, and sends the extracted words to the character pronunciation appendage unit 102. The text data is, for example, text data related to a setting where speech recognition may be utilized. A word may be configured of one or more morphemes. The word extraction unit 101 performs morphological analysis on text data, and extracts candidate words to be added to the speech recognition dictionary based on the result of the morphological analysis. The words output from the word extraction unit 101 may be words with substantial meanings, such as nouns, verbs, adjectives, and adverbs. The words output from the word extraction unit 101 may include compound words (e.g., compound nouns in which multiple nouns are joined).

The technical terms and/or unknown words may be candidates to be added to the speech recognition dictionary. The unknown words are words that do not exist in the speech recognition dictionary. In the present embodiment, the word extraction unit 101 extracts, from text data, technical terms and unknown words. Example methods that may be used to extract technical terms include: a method of performing morphological analysis on text data to obtain multiple words and extracting words that occur frequently in the text data (e.g., the frequency of occurrence exceeding a threshold value) as technical terms; a method of performing morphological analysis on text data to obtain multiple words and extracting, as technical terms, words that rarely occur in text data in a field different from that of the text data received by the word extraction unit 101. Example methods that may be used to extract unknown words include a method of performing morphological analysis on text data to obtain multiple words and extracting words not currently included in the speech recognition dictionary. Such methods may be used in combination. For example, the word extraction unit 101 may extract technical terms from the text data and extract words not included in the speech recognition dictionary from these extracted technical terms. Existing methods other than those described above may be used.

The character pronunciation appendage unit 102 appends character pronunciations to the words extracted by the word extraction unit 101, and registers word information including the extracted words and the character pronunciations appended thereto in the word list 103.

Example methods that can be used to append character pronunciations to words include a method of using a word dictionary with character pronunciations, and a statistical method of learning character pronunciations of characters in advance with a large amount of data and appending the character pronunciations to the words using the learned results. In the method of using a word dictionary with character pronunciations, in the case of a word registered in the word dictionary, a character pronunciation associated with the word is appended to the word, and in the case of a word that is a combination of multiple words registered in the word dictionary, a character pronunciation obtained by connecting the character pronunciations associated with the words is appended to the word, taking into account sequential voicing, etc. Existing methods other than those described above may be used.

The word list 103 may store a plurality of word character pronunciation pairs. Each word character pronunciation pair is a pair of a word and its character pronunciation.

The modification acceptance unit 104 accepts, from the user, a modification to word information registered in the word list 103. Example types of modifications include deletion of a word, deletion of part of a word, addition of one or more characters to a word, addition of a word, correction to a character pronunciation, etc. Deletion of part of a word and addition of one or more characters to a word may be collectively referred to as “correction to a word”. When a modification is made on word information registered in the word list 103, the modification acceptance unit 104 updates the word list 103 based on details of the modification.

When a modification is made on word information registered in the word list 103, the modification candidate specification unit 105 specifies a modification candidate that is either a word or a character pronunciation to be modified in relation to the modification, and notifies the display unit 106 of the specified modification candidate. A method of specifying the modification candidate will be described later.

The display unit 106 displays the word list 103. Specifically, the display unit 106 displays word information registered in the word list 103. Furthermore, the display unit 106 highlights a word or character pronunciation specified as a modification candidate by the modification candidate specification unit 105 on a screen. A method of highlighting a modification candidate will be described later.

In the word list 103, a word character pronunciation pair may be associated with edit information. The edit information includes, for example, a candidate flag. The candidate flag is a flag indicating whether or not the word character pronunciation pair is a candidate to be added to the speech recognition dictionary. For example, a candidate flag “0” indicates that the word character pronunciation pair is a candidate to be added to the speech recognition dictionary, and the candidate flag “1” indicates that the word character pronunciation pair is not a candidate to be added to the speech recognition dictionary. For example, when a user performs an operation to delete a word, a candidate flag of the word is changed from “0” to “1”. Upon completion of a modification operation by the user, the dictionary editing apparatus 100 outputs a word character pronunciation pair whose candidate flag is “0” to be added to the speech recognition dictionary. In an example, the dictionary editing apparatus 100 may register a word character pronunciation pair in the speech recognition dictionary. In another example, the dictionary editing apparatus 100 may send a word character pronunciation pair to another apparatus (not illustrated) that registers a word character pronunciation pair in the speech recognition dictionary.

Next, an operation of the dictionary editing apparatus 100 will be described.

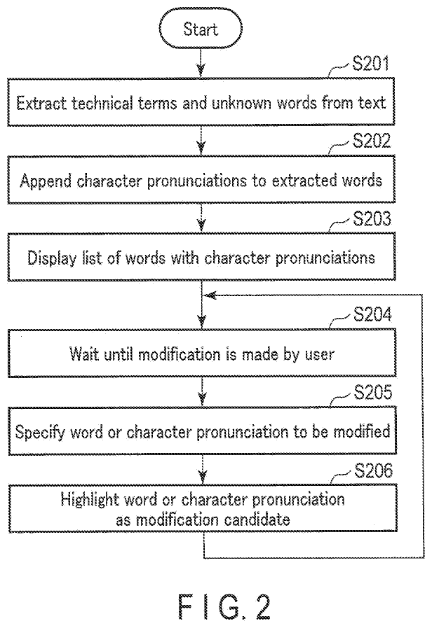

FIG. 2 schematically shows an operation example of the dictionary editing apparatus 100. The word extraction unit 101 receives text data input by the user, and extracts technical terms and unknown words from the text data (step S201 in FIG. 2). The character pronunciation appendage unit 102 respectively appends character pronunciations to words extracted as technical terms or unknown words (step S202). The extracted words and the appended character pronunciations are associated with each other and registered in the word list 103.

The display unit 106 displays words and character pronunciations registered in the word list 103 (step S203). The dictionary editing apparatus 100 waits until the user checks the displayed words and character pronunciations and makes a modification on any word or character pronunciation (step S204).

When a modification is made by the user, the modification candidate specification unit 105 specifies the word or character pronunciation to be modified in relation to the modification as a modification candidate (step S205). The display unit 106 highlights the word or character pronunciation specified as a modification candidate (step S206). Since a user is considered to make a further modification based on the highlighting, the processing reverts to step S204 where the dictionary editing apparatus 100 waits for a modification by the user. When a further modification is made, a similar flow of specifying and highlighting other modification candidates is repeated.

In the example shown in FIG. 2, character pronunciation appendage is performed after word extraction; however, word extraction may be performed after appending a character pronunciation. Extracting a word from text data and appending a character pronunciation to the word may be either of: extracting a word from text data and appending a character pronunciation to the extracted word; or appending a character pronunciation to the text data and extracting a word with a character pronunciation from the text data.

Next, a method of specifying a modification candidate and a method of highlighting will be described. Herein, an example (hereinafter referred to as a “referential example”) will be frequently referred to in which the word extraction unit 101 has extracted, from the text “ . . . [symbol] [symbol] . . . Toshiba . . . Toshiba Corporation . . . ”, the words “ [symbol] ”, “ [symbol] ”, “Toshiba”, and “Toshiba Corporation”, to which the character pronunciation appendage unit 102 has appended the character pronunciations “ [symbol] ” (“senmon-yö”), “ [symbol] ” (“go chüshutsu”), “ [symbol] ” (“toshiba”), “ [symbol] ” (“toshiba köporëshon”). The word “ [symbol] ” corresponds to ‘technical term extraction’, the word “ [symbol] ” corresponds to ‘for specialty’, and the word “ [symbol] ” corresponds to ‘word extraction’.

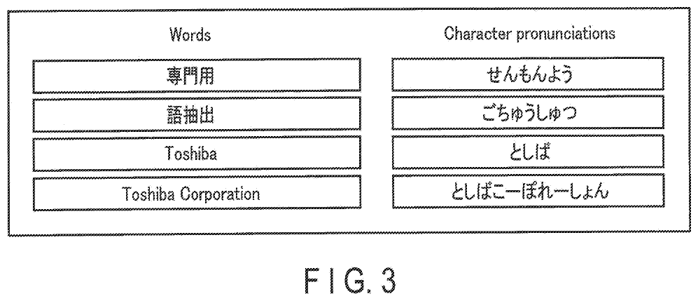

The dictionary editing apparatus 100 provides, to the user, a user interface for making a modification. The display unit 106 displays word information registered in the word list 103 on a screen of a user interface. In the referential example, as shown in FIG. 3, the display unit 106 displays a list of four word character pronunciation pairs, including: a pair of the word “ [symbol] ” and its character pronunciation “ [symbol] ”, a pair of the word “ [symbol] ” and its character pronunciation “ [symbol] ”, a pair of the word “Toshiba” and its character pronunciation “ [symbol] ”, and a pair of the word “Toshiba Corporation” and its character pronunciation “ [symbol] ”.

When a modification to delete a word or part of a word is made, the modification candidate specification unit 105 specifies, of the words registered in the word list 103, a word adjacent on text data to the word to which the modification has been made as a modification candidate. It can be construed that a modification to delete a word or part of a word is caused by an error in morphological analysis, and that a word adjacent to the word on text data is obtained by an error in morphological analysis.

In the referential example, the phrase “ [symbol] ” is divided into “ [symbol] ” and “ [symbol] ” by an error in morphological analysis. When a modification is made to delete “ [symbol] ” or a modification to delete “ [symbol] ” which is part of “ [symbol] ”, the modification candidate specification unit 105 specifies, as a modification candidate, the word “ [symbol] ” adjacent on the text data to the word “ [symbol] ” to which the modification has been made. The word “ [symbol] ” is specified as a modification candidate that should be either deleted or corrected to “ [symbol] ” or “ [symbol] ” (‘term extraction’). Here, whether the word “ [symbol] ” is to be a deletion candidate or a correction candidate may depend on, for example whether the word obtained by the correction (in this example, “ [symbol] ” or “ [symbol] ”) deserves to be extracted as a technical term or an unknown word, or whether the word obtained by the correction is included in the word list 103.

When a modification to add a character to a word is made, the modification candidate specification unit 105 specifies a partial word of the word obtained by the modification (a part of the word obtained by the modification) as a modification candidate. When, for example, a word that matches the partial word exists in the word list 103, the modification candidate specification unit 105 specifies the word as a modification candidate (specifically, a deletion candidate), and if a word that matches the partial word does not exist in the word list 103, the partial word may be specified as a modification candidate (specifically, an addition candidate).

In the referential example, when a modification to add the characters “ [symbol] ” is made to the word “ [symbol] ”, the word obtained by the modification will be “ [symbol] ”, and the partial words can be, for example, “ [symbol] ”, “ [symbol] ” (‘extraction’), “ [symbol] ” (‘term’), “ [symbol] ”, “ [symbol] ” (‘technical term’), etc. The “ [symbol] ” may exist in the word list 103, and the modification candidate specification unit 105 may specify the word “ [symbol] ” as a deletion candidate. The “ [symbol] ” may not exist in the word list 103, and the modification candidate specification unit 105 may specify the word “ [symbol] ” as an addition candidate. In this case, the modification candidate specification unit 105 may append a character pronunciation to the word “ [symbol] ”, which is an addition candidate, using the character pronunciation appendage unit 102, register the word “ [symbol] ” and a character pronunciation appended thereto to the word list 103, allowing the display unit 106 to then display and highlight the word “ [symbol] ”.

Alternatively, when a modification is made to add a character to a word, the modification candidate specification unit 105 may specify, among the words registered in the world list 103, a word adjacent on text data to the word to which the modification has been made as a modification candidate (specifically, a deletion candidate). When, for example, a modification to add a character “ [symbol] ” to the word “ [symbol] ” is made in the referential example, since the word adjacent to “ [symbol] ” on the text data, of the words registered in the word list 103, is “ [symbol] ”, the word “ [symbol] ” is specified as a deletion candidate.

Alternatively, when a modification to add a character to a word is made, the modification candidate specification unit 105 may specify a word that is adjacent to the word obtained by the modification on text data and does not exist in the word list 103 as a modification candidate (specifically, an addition candidate). When, for example, a modification to add a character “ [symbol] ” to the word “ [symbol] ” is made in the referential example, since the word adjacent on the text data to “ [symbol] ” is “ [symbol] ”, the word “ [symbol] ” is specified as an addition candidate.

When a modification to newly add a word is made, the modification candidate specification unit 105 may specify the modification candidate in a manner similar to that described in the case where a modification to add a character to a word is made. Specifically, the modification candidate specification unit 105 specifies a partial word of the added word (part of the added word) as a modification candidate. When, for example, a word that matches the partial word exists in the word list 103, the modification candidate specification unit 105 specifies the word as a modification candidate (specifically, a deletion candidate), and if a word that matches the partial word does not exist in the word list 103, the partial word may be specified as a modification candidate (specifically, an addition candidate). For example, when a modification to add the word “ [symbol] ” is made, the modification candidate specification unit 105 may specify the word “ [symbol] [symbol] ” and the word “ [symbol] ” in the word list 103 as deletion candidates. When, for example, a modification to add the word “ [symbol] ” is made, the modification candidate specification unit 105 may specify the word “ [symbol] ” that is not present in the word list 103 as an addition candidate.

Alternatively, when a modification to newly add a word is made, the modification candidate specification unit 105 may specify, among the words registered in the world list 103, a word adjacent to the added word on the text data as a modification candidate (specifically, a deletion candidate). Alternatively, when a modification to newly add a word is made, the modification candidate specification unit 105 may specify a word that is adjacent to the added word on the text data and does not exist in the word list 103 as a modification candidate (specifically, an addition candidate).

The modification candidate specification unit 105 may adjust the word extraction method of the word extraction unit 101 based on details of the modification by the user, and may specify the modification candidate based on the results obtained by the word extraction according to the adjusted word extraction method. When, for example, a modification to correct or delete a word is made, the modification candidate specification unit 105 adjusts the word extraction method of the word extraction unit 101 in such a manner that the word to which the modification has been made is not extracted from the text data, or the word obtained by the correction is extracted from the text data. When, for example, a modification to add a word is made, the modification candidate specification unit 105 adjusts the word extraction method of the word extraction unit 101 in such a manner that the added word is extracted from the text data. When, for example, the word extraction method of the word extraction unit 101 is a method of extracting a word based on a certain threshold value, a method of increasing the threshold value to a score of the word to which the modification has been made, and specifying another word whose score has become equal to or below a threshold value as a modification candidate (specifically, a deletion candidate) may be used. When the added word or the word obtained by the correction is contained in the text data, and a score of the word is calculated at the time of extraction of the word, the threshold value may be decreased to that score, and another word whose score has become equal to or greater than the threshold value may be specified as a modification candidate (specifically, an addition candidate).

When a modification to correct a character pronunciation is made, the modification candidate specification unit 105 may specify a character pronunciation of a word that is similar in notation to the word whose character pronunciation has been corrected as a modification candidate. A first word being similar to a second word in notation means that the first word includes at least part of the second word. In the referential example, when a modification to correct the character pronunciation of the word “Toshiba” from “ [symbol] ” (“toshiba”) to “ [symbol] ” (“töshiba”) is made, the modification candidate specification unit 105 specifies the character pronunciation “ [symbol] ” (“toshiba köporëshon”) of the word “Toshiba Corporation” including the word “Toshiba” as a modification candidate. In the reference example, when a modification to correct the character pronunciation of the word “Toshiba Corporation” from “ [symbol] ” (“toshiba köporëshon”) to “ [symbol] [symbol] ” (“töshiba köporëshon”) is made, the modification candidate specification unit 105 specifies the character pronunciation “ [symbol] ” (“toshiba”) of the word “Toshiba” including part of the word “Toshiba Corporation” as a modification candidate.

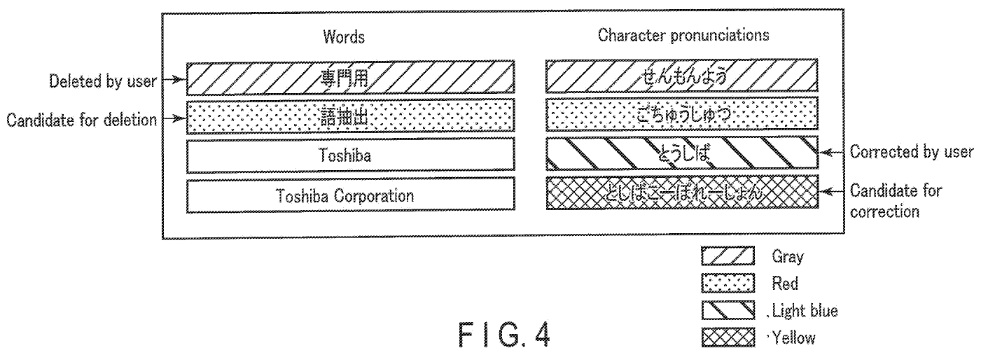

The display unit 106 highlights the modification candidate on a screen upon which word information registered in the word list 103 is displayed. As an example, the display unit 106 changes the background color of a field (also referred to as a “cell”, a “box”, or a “textbox”) that stores the word or character pronunciation specified by the modification candidate specification unit 105 as a modification candidate. In the referential example, when the user deletes the word “ [symbol] ” and the modification candidate specification unit 105 specifies the word “ [symbol] ” as a deletion candidate, the display unit 106 changes the background color of the field of the word “ [symbol] [symbol] ” to, for example, red, as shown in FIG. 4. Further, when the user corrects the character pronunciation of the word “Toshiba” to “ [symbol] ” (“töshiba”), and the modification candidate specification unit 105 specifies the character pronunciation “ [symbol] [symbol] ” (“toshiba köporëshon”) as a correction candidate, the display unit 106 changes the background color of the field of the character pronunciation “ [symbol] [symbol] ” (“toshiba köporëshon”) to, for example, yellow, as shown in FIG. 4.

The display unit 106 may use different colors according to the type of the modification candidate. For example, the deletion candidate is displayed in red, the correction candidate is displayed in yellow, and the addition candidate is displayed in green. The display unit 106 may not only highlight the word or character pronunciation specified as a modification candidate, but also highlight the character pronunciation or word corresponding thereto. In the example shown in FIG. 4, the background color of the field of the character pronunciation “ [symbol] ” (“go chüshutsu”) of the word “ [symbol] ” specified as a deletion candidate is changed to the same background color as that of the field of the word “ [symbol] [symbol] ”.

Also, the display unit 106 may be configured to highlight the word or character pronunciation to which a modification has been made. For example, the display unit 106 may change the background color of the field of the word or character pronunciation to which a modification has been made to one different from that of the modification candidate. The modification candidate specification unit 105 may determine the type of modification made by the user, and the display unit 106 may change the manner of highlighting (e.g., using different colors) according to the determination results. The display unit 106 may not only highlight the word or character pronunciation to which the modification has been made, but also highlight the character pronunciation or word corresponding thereto.

When the user performs a modification to delete the word “ [symbol] ”, the display unit 106 changes the background color of the field of the deleted word “ [symbol] ” and its character pronunciation “ [symbol] ” (“senmon-yö”) to, for example, gray. When the user makes a modification to correct the character pronunciation of the word “Toshiba” to “ [symbol] ” (“töshiba”), the display unit 106 displays the corrected character pronunciation “ [symbol] ” (“töshiba”), and changes the background color of the field to, for example, light blue.

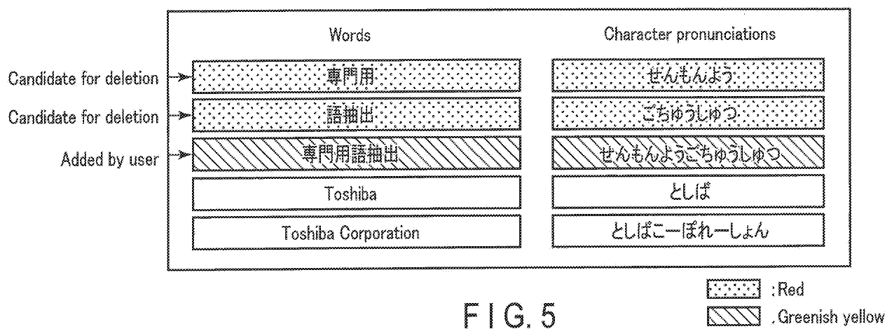

When the user adds the word “ [symbol] ” and the modification candidate specification unit 105 specifies the words “ [symbol] ” and “ [symbol] ” as deletion candidates, the display unit 106 changes the background color of the field of the word “ [symbol] ” and its character pronunciation “ [symbol] [symbol] ” and the word “ [symbol] ” and its character pronunciation “ [symbol] ” to, for example, red, and changes the background color of the field of the word “ [symbol] ” and its character pronunciation “ [symbol] [symbol] ” to, for example, greenish yellow, as shown in FIG. 5.

The highlighting method is not limited to changing the background color of the field. The highlight method may be, for example, thickening the frame of the field, changing the color of the frame of the field, increasing the size of the frame of the field, changing the color of the characters in the field, changing the size of the characters in the field, or changing the font of the characters in the field. The changing the font includes, for example, changing the style, bolding, italicizing, underlining, etc.

The display unit 106 may perform highlighting using one of the above-described highlighting methods, or two or more such methods in combination. In other words, the display unit 106 may change at least one of the background color of the field that stores the modification candidate, the size of the frame of the field, the color of the frame of the field, the color of the characters in the field, the size of the characters in the field, or the font of the characters in the field. The display unit 106 may use a highlighting method different from the above-described highlighting method.

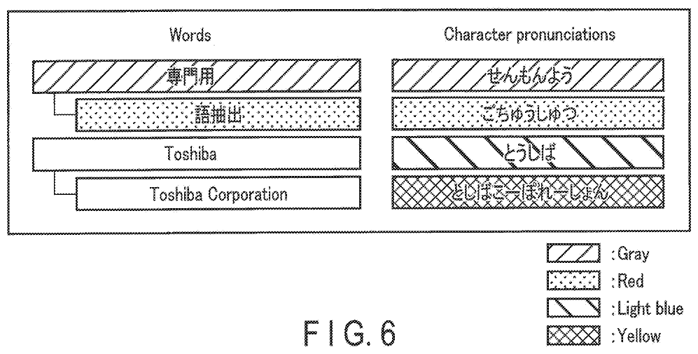

When the display unit 106 highlights the modification candidate, the word or character pronunciation specified as a modification candidate in response to a modification by the user may be displayed in association with the word or character pronunciation to which the modification has been made. In an example, the display unit 106 may move the word or character pronunciation specified as a modification candidate immediately below the word or character pronunciation to which a modification has been made. In another example, the display unit 106 may explicitly show that the word or character pronunciation to which a modification has been made is linked with the modification candidate, by connecting the word or character pronunciation to which the modification has been made to a correction candidate with a line, as shown in FIG. 6. In the example shown in FIG. 6, through deletion of the word “ [symbol] ” by the user, the word “ [symbol] ” is specified as a modification candidate, and the word “ [symbol] ” is joined with the word “ [symbol] ” with a line. Furthermore, through the correction of the character pronunciation “ [symbol] ” by the user, the character pronunciation “ [symbol] ” is specified as a modification candidate, and the word [symbol] “Toshiba” corresponding to the character pronunciation “ [symbol] [symbol] ” is joined with the word “Toshiba Corporation” corresponding to the character pronunciation “ [symbol] [symbol] ” with a line. In another example, the display unit 106 may arrange a modification candidate at the top of the list.

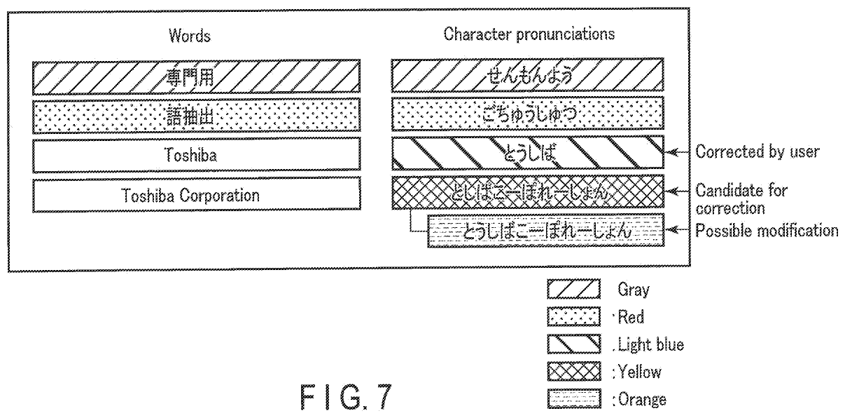

The modification candidate specification unit 105 may generate a possible modification to a word or character pronunciation specified as a correction candidate, and the display unit 106 may display a possible modification generated by the modification candidate specification unit 105, in addition to highlighting the word or character pronunciation specified as a correction candidate. The display unit 106 may highlight the possible modification. In this case, the modification candidate specification unit 105 sends information indicating the possible modification to display unit 106. When, for example, the character pronunciation of the word “Toshiba” is corrected from “ [symbol] [symbol] ” to “ [symbol] ”, the modification candidate specification unit 105 specifies the character pronunciation “ [symbol] [symbol] ” as a correction candidate, and generates a possible modification “ [symbol] [symbol] ” based on details of the modification. The display unit 106 may display a possible modification in parallel with the original character pronunciation, as shown in FIG. 7. Moreover, a possible modification may be displayed in the form of a drop-down list when the highlighted field is clicked. Furthermore, a possible modification may be displayed in a pop-up screen when a cursor is placed on the highlighted field. Conversely, the original character pronunciation may be displayed in a pop-up screen when a possible modification is highlighted and a cursor is placed on the field in which the possible modification is displayed.

As described above, the dictionary editing apparatus 100 extracts words from text data, appends character pronunciations to the extracted words, specifies, when a modification to word information including the extracted word and the appended character pronunciation is made, a word or character pronunciation to be modified in relation to the modification, and presents the specified word or character pronunciation to the user. Such specifying allows the user modifying a word or character pronunciation to easily find the next word or character pronunciation to be checked. This concomitantly results in reduced costs for checking and modification of word extraction and character pronunciation appendage results.

The above-described process regarding the dictionary editing apparatus 100 can be implemented through execution of a program by general-purpose circuitry such as a central processing unit (CPU).

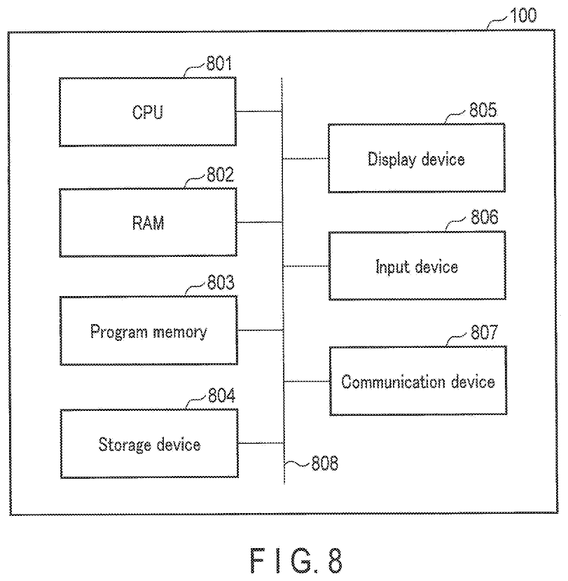

FIG. 8 schematically shows a hardware configuration example of the dictionary editing apparatus 100. In the example shown in FIG. 8, the dictionary editing apparatus 100 is a computer including a CPU 801, a random-access memory (RAM) 802, a program memory 803, a storage device 804, a display device 805, an input device 806, a communication device 807, and a bus 808. The CPU 801 exchanges signals with the RAM 802, the program memory 803, the storage device 804, the display device 805, the input device 806, and the communication device 807 via the bus 808.

The CPU 801 is an example of general-purpose circuitry. The RAM 802 is used by the CPU 801 as a working memory. The RAM 802 includes a volatile memory such as a synchronous dynamic random-access memory (SDRAM). The program memory 803 may store programs that are executed by the CPU 801, such as a dictionary editing program. The programs include computer-executable instructions. As the program memory 803, a read-only memory (ROM), for example, may be used.

The CPU 801 loads a program stored in the program memory 803 onto the RAM 802, and interprets and executes the program. The dictionary editing program causes, when executed by the CPU 801, the CPU 801 to perform the above-described processing regarding the dictionary editing apparatus 100. In other words, the CPU 801 functions as the word extraction unit 101, the character pronunciation appendage unit 102, the modification acceptance unit 104, the modification candidate specification unit 105, and the display unit 106 in accordance with the dictionary editing program. The word list 103 is implemented by the RAM 802 and/or the storage device 804.

Programs such as the dictionary editing program may be provided to the dictionary editing apparatus 100 in a state of being stored in a computer-readable storage medium. In this case, for example, the dictionary editing apparatus 100 includes a drive for reading data from the storage medium, and acquires a program from the storage medium. Examples of the storage medium include a magnetic disk, an optical disk (e.g., a CD-ROM, a CD-R, a DVD-ROM, a DVD-R, etc.) a magneto-optical disk (e.g., an MO), and a semiconductor memory. Programs may be stored in a server on a network, and the dictionary editing apparatus 100 may be configured to download the programs from the server.

The storage device 804 stores data. The storage device 804 includes non-volatile memories such as a hard disk drive (HDD) or a solid-state drive (SSD). A partial region of the storage device 804 may be used as the program memory 803.

The display device 805 may be, for example, a liquid-crystal display, an organic light-emitting diode (OLED) display, etc. The display device 805 displays an image generated by the display unit 106, such as a screen of a user interface for making a modification.

The input device 806 is a device for allowing the user to input information. The input device 806 includes, for example, a keyboard and a mouse. The input device 806 is used to perform a modification to word information.

The communication device 807 is an interface for communicating with an external device. The communication device 807 includes, for example, a wired and/or wireless communication module.

At least part of the above-described process regarding the dictionary editing apparatus 100 may be implemented by dedicated circuitry such as an application-specific integrated circuit (ASIC) or a field-programmable gate array (FPGA).

A configuration in which a terminal device operated by the user is provided separately from the dictionary editing apparatus 100 may be adopted. In such a configuration, the dictionary editing apparatus 100 performs communications with the terminal device using the communication device 807.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A dictionary editing apparatus comprising:
processing circuitry configured to:
extract words from text data;
append character pronunciations to the extracted words; and
specify, when a modification is made to word information including the extracted words and the appended character pronunciations, a modification candidate that is a word or character pronunciation to be modified in relation to the modification.

2. The dictionary editing apparatus according to claim 1, wherein the processing circuitry is configured to specify, of the extracted words, a word adjacent on the text data to a word to which the modification has been made as the modification candidate.

3. The dictionary editing apparatus according to claim 1, wherein the processing circuitry is configured to:
adjust, when the modification comprises an addition of a first word or deletion or correction of a second word among the extracted words, a word extraction method in such a manner that the second word is not extracted from the text data or that the first word or a third word obtained by the correction is extracted from the text data; and
specify the modification candidate based on a result of word extraction performed on the text data according to the adjusted word extraction method.

4. The dictionary editing apparatus according to claim 1, wherein the processing circuitry is configured to specify, as the modification candidate, a word similar in notation to a word to which the modification has been made.

5. The dictionary editing apparatus according to claim 1, wherein the processing circuitry is configured to specify, as the modification candidate, a character pronunciation of a word similar in notation to a word corresponding to a character pronunciation to which the modification has been made.

6. The dictionary editing apparatus according to claim 1, wherein the processing circuitry is configured to display and highlight the modification candidate.

7. The dictionary editing apparatus according to claim 6, wherein the processing circuitry is configured to:
determine a type of the modification; and
change a manner of highlighting according to a result of the determination of the type.

8. The dictionary editing apparatus according to claim 6, wherein the processing circuitry is configured to:
generate a possible modification to the word or character pronunciation specified as the modification candidate, and
display the possible modification.

9. The dictionary editing apparatus according to claim 8, wherein the processing circuitry is configured to display the possible modification in association with the modification candidate.

10. The dictionary editing apparatus according to claim 6, wherein the processing circuitry is configured to display the word or character pronunciation specified as the modification candidate in association with a word or character pronunciation to which the modification has been made.

11. The dictionary editing apparatus according to claim 6, wherein processing circuitry is configured to change at least one of: a background color of a field that stores the modification candidate; a size of a frame of the field; a color of the frame of the field; a color of characters in the field; a size of the characters in the field; or a font of the characters in the field.

12. A dictionary editing method comprising:
extracting words from text data;
appending character pronunciations to the extracted words; and
specifying, when a modification is made to word information including the extracted words and the appended character pronunciations, a modification candidate that is a word or character pronunciation to be modified in relation to the modification.

13. A non-transitory computer readable medium including computer executable instructions, wherein the instructions, when executed by a processor, cause the processor to perform a method comprising:
extracting words from text data;
appending character pronunciations to the extracted words; and
specifying, when a modification is made to word information including the extracted words and the appended character pronunciations, a modification candidate that is a word or character pronunciation to be modified in relation to the modification.
